(19) United States
(12) Patent Application Publication
(10) Pub. No.: US 2015/0336776 A1
(43) Pub. Date: Nov. 26, 2015

(54) UTILITY TRUCK WITH BOOM AND DEFORMATION MONITORING SENSORS

(71) Applicant: POSI-PLUS TECHNOLOGIES INC., VICTORIAVILLE (CA)

(72) Inventor: JEAN-FRANCOIS ST-YVES, TROIS-RIVIERES (CA)

(21) Appl. No.: 14/718,643

(22) Filed: May 21, 2015

Related U.S. Application Data
(60) Provisional application No. 62/001,134, filed on May 21, 2014.

(51) Int. Cl. B66C 13/20; B66C 15/06; B66C 23/90; B66C 23/42

(52) U.S. Cl. CPC B66C 13/20; B66C 23/42; B66C 15/06; B66C 23/90

(57) ABSTRACT

A utility truck including a boom with telescoping segments, and pistons connected to two pivot points on a base bracket of the boom, for raising and lowering the boom. The truck includes first and second sensors each mounted at different locations on the extension bracket. Both sensors monitor deformations of the extension bracket. An average of measurements of the sensors provide a first load value representative of an axial deflection of the boom. A difference between the measurements of the sensors provide a second load value representative of a lateral deflection of the boom. A control system receives signals from the sensors and controls power delivered to the pistons based on the received signals.

### CROSS-REFERENCE TO RELATED APPLICATIONS

This application claims benefit of U.S. provisional application Ser. No. 62/001,134, filed on filed May 21, 2014. All documents above are incorporated herein in their entirety by reference.

### FIELD OF THE INVENTION

The present invention relates to a utility truck provided with a boom and a hydraulic system for actuating the boom.

### BACKGROUND OF THE INVENTION

The prior art reveals hydraulic systems for actuating the boom of a utility truck. During use, forces exerted on the boom may exceed predetermined thresholds and compromise security. One solution to this problem has been to monitor changes in hydraulic pressure in the hydraulic system to try to detect such excessive forces. However, such monitoring is not precise.

### SUMMARY OF THE INVENTION

In order to address the above and other drawbacks, there is provided a utility truck comprising: a boom including two or more telescoping segments for sliding relative to one another; one or more pistons, each piston having a first end pivotally connected to a first pivot point of a base bracket of said boom and a second end pivotally connected to a second pivot point on an extension bracket of said boom, for raising and lowering said boom; first and second sensors each mounted at different locations on said extension bracket, both sensors monitoring deformations of said extension bracket, an average of measurements of the first and second sensors providing a first load value representative of an axial deflection of the boom, a difference between the measurements of the first and second sensors providing a second load value representative of a lateral deflection of the boom; and a control system for receiving signals from said first and second sensors and controlling power delivered said one or more pistons based on said received signals.

### BRIEF DESCRIPTION OF THE DRAWINGS

FIG. 1 is a perspective side view of a utility truck in accordance with an illustrative embodiment of the present invention;

FIG. 2 is a perspective under view of the utility truck shown in FIG. 1;

FIG. 3 is a more detailed under view of a portion of the truck shown in FIG. 2;

FIG. 4 is an over view block diagram of a hydraulic system in accordance with an illustrative embodiment of the present invention; and

FIG. 5 is a detailed schematic block diagram of a hydraulic system in accordance with an illustrative embodiment of the present invention.

### DETAILED DESCRIPTION OF THE ILLUSTRATIVE EMBODIMENTS

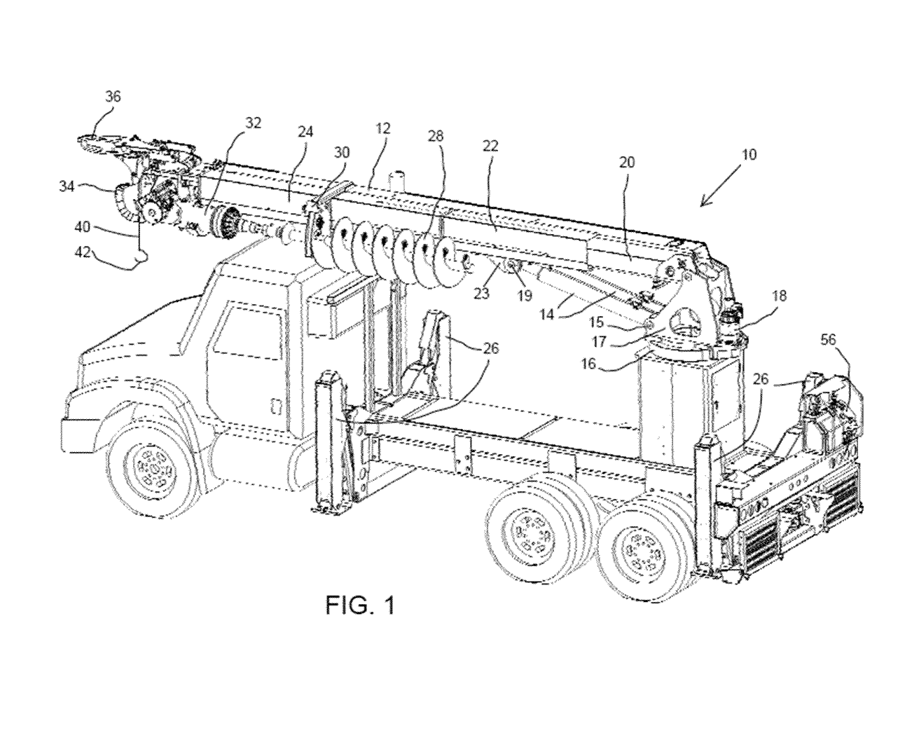

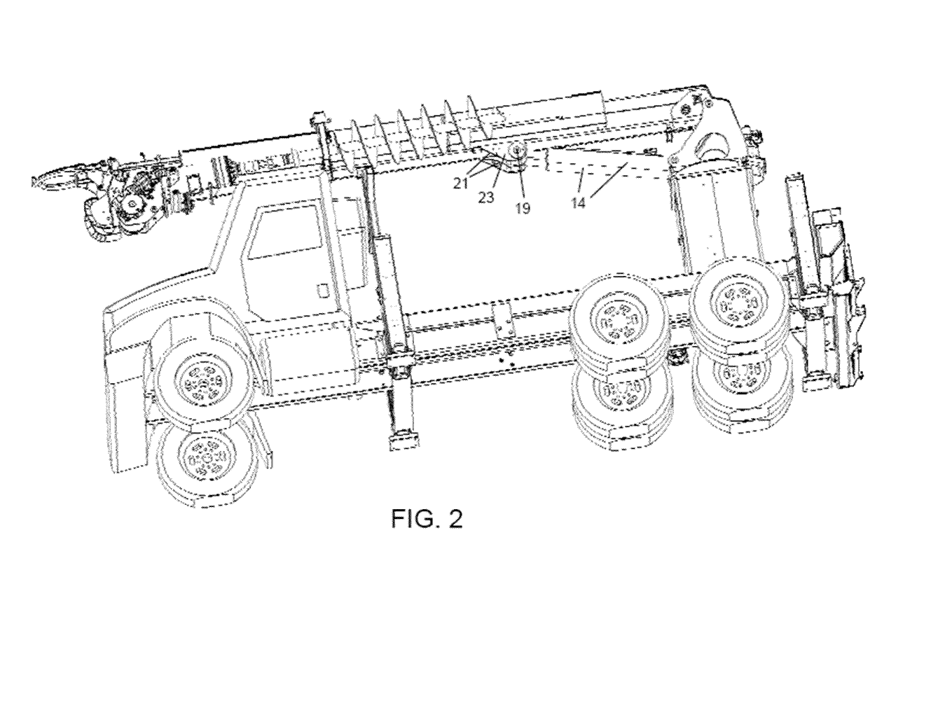

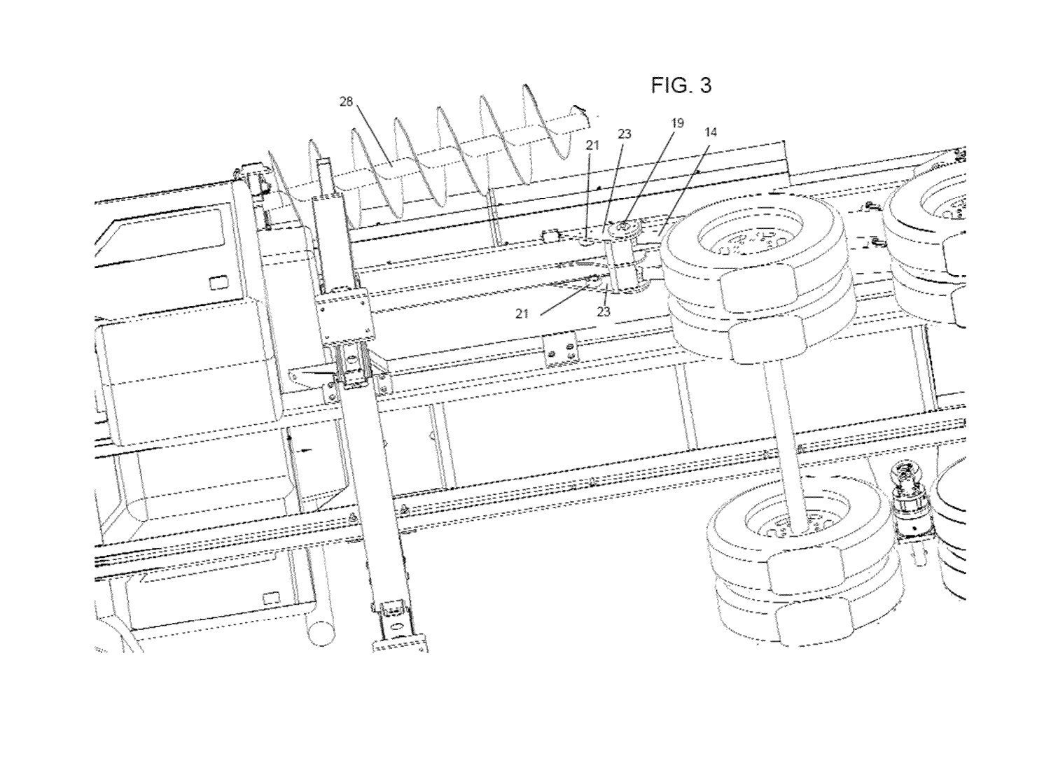

Now referring to FIGS. 1, 2 and 3, a utility truck, generally referred to using the reference numeral 10, will now be described. Illustratively, the utility truck 10 is equipped with a multiple of hydraulically powered devices which are used to set utility poles into the ground. A boom/crane 12 is provided which can be raised and lowered through action of one or more pistons 14 and rotated around a base plate 16 through actuation of a hydraulic motor 18. Two pistons 14 are shown in the illustrated example. Each piston 14 has a first end pivotally connected to a first pivot point 15 of a first bracket 17 that is mounted on a base plate 16. A second end of each piston 14 is pivotally connected to a second pivot point 19 on an extension bracket 23 of the boom 12. The boom 12 is comprised of one or more telescoping segments 20, 22, 24 which are arranged for sliding relative to one another and under control of a plurality of hydraulic pistons (not shown). In order to stabilize the utility truck 10 during raising, rotating and extending the boom 12, opposed pairs of hydraulically actuated outriggers as in 26 are provided. An auger 28, illustratively shown in a stored position for travel where the auger 28 is secured against the boom 12 by a releasable locking support 30, driven by a hydraulic motor 32 is provided for excavating holes into which a utility pole (not shown) can be placed. A pole tilt 34 comprising a pair of opposed hydraulically actuated pole grasping jaws 36 is provided for grabbing and manipulating the utility pole. In order to draw the utility pole into the jaws, for example, a hydraulic winch 38 and associated cable 40, illustratively terminated by a hook 42, is also provided. A control panel 56 is located at the back of the utility truck 10. First and second sensors 21 are respectively mounted to the bracket 23 of the second segment 24 of the boom 12 for monitoring a deformation of the bracket 23 during use of the boom 12. An average of measurements of the first and second sensors 21 provides first load values representative of axial (vertical) deflections of the boom 12. A difference between the measurements of the first and second sensors 21 provides second load values representative of lateral (horizontal) deflections of the boom 12. In this way, it is possible to precisely determine excessive load strains exerted on the boom. The sensors 21 may be mounted on opposite sides of the boom 12 and at the same distance from its center in a symmetrical configuration. The sensors 21 are preferably housed inside a casing filled with silicone gel for their protection.

As was discovered by the Applicant, if the sensors 21 are positioned at other positions on the boom 12, for example directly on a section 20, 22, 24 of the boom as opposed to the bracket 23, these sensors provide unreliable or imprecise measurements. Indeed, in such configuration, as the telescoping segments 20, 22, 24 move over the sensors 21, this severely affects the measurements thereof. The sensors 21 used may be those made by Flexco Industries Inc. U.S. Pat. No. 8,215,178, which is incorporated by reference, discloses examples of such sensors. Each sensor 21 may comprise strain gages or like semi-conductors, arranged in a Wheatstone bridge configuration, and oriented so as to detect load, pressure, deformations along different orientations.

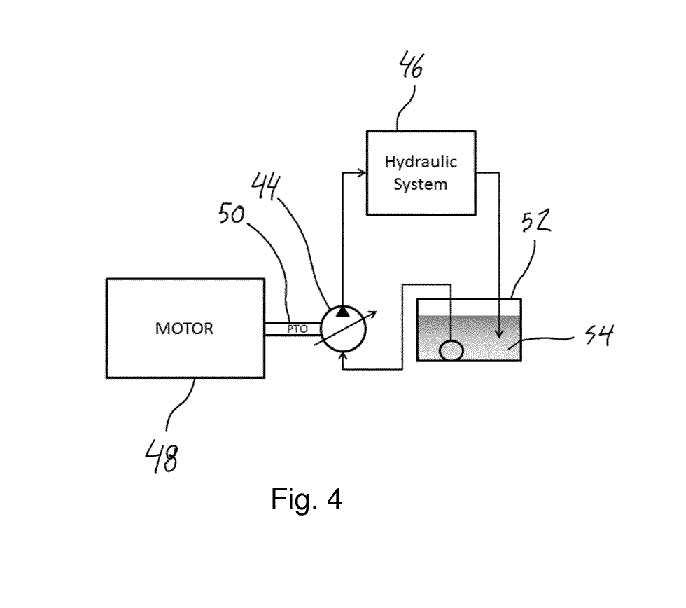

Referring now to FIG. 4 in addition to FIGS. 1 to 3, power for driving the pump(s) 44 which drive the hydraulic system(s) 46 are provided by the utility truck motor 48 via a power take off (PTO) 50. A tank 52 is also provided as reservoir for hydraulic fluid 54. An operator can control the elements of the hydraulic system 46 via the control panel 56.

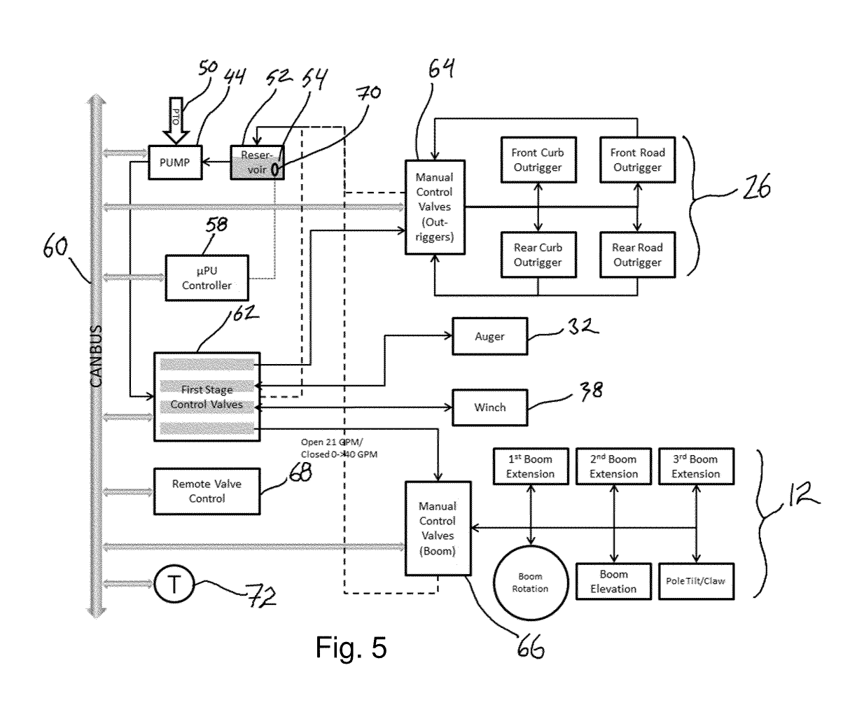

Referring now to FIG. 5, the hydraulic system is controlled by a controller 58 which communicates with the various components of the hydraulic system via a standardized communications bus 60 such as CANBUS or the like. The hydraulic system comprises a series of electronically flow and pressure controllable first stage control valves 62. The first stage control valves 62 are able to controllably supply a high flow of hydraulic fluid to the manual control valves 64, 66 which form part of the control panel 56 and operate respectively the stabilizing outriggers 26 or the boom 12, or other hydraulic subsystems, such as the auger motor 32 or the winch 38. Remote valve control 68 can also be provided for some or all of the hydraulic subsystems. A thermostat 70 is also provided for measuring the temperature of the system, and which is for example positioned within the hydraulic fluid 54 held within the tank 52. In a particular embodiment a thermostat 72 may also be located elsewhere within the utility truck 10.

In use, the controller 58 receives signals from the sensors 21 that detect deformation forces exerted on the bracket 23 which are representative of the axial (vertical) and lateral (horizontal) forces exerted on the boom. The controller 58 can then control the hydraulic power of the boom 12 and pistons 14 or other hydraulic components based on the received signals. In particular, if the forces exerted on the boom 12 exceed predetermined thresholds, then the controller 58 may shut down the hydraulic power or slow down the speed of operation. The controller 58 may also emit an alarm.

Thus, the control system 58 may configured to shut down the power delivered to the pistons 14 when a force threshold reaches a predetermined threshold. It may also be configured to reduce the power delivered to the pistons 14 when a force threshold reaches another predetermined threshold so as to slow down the speed of operation of the pistons 14. The control system may also be configured to emit different alarms when the force threshold reaches one or any other predetermined thresholds.

Although the present invention has been described hereinabove by way of specific embodiments thereof, it can be modified, without departing from the spirit and nature of the subject invention defined in the appended claims.

1. A utility truck (10) comprising:
a boom (12) including two or more telescoping segments (20, 22, 24) for sliding relative to one another;
one or more pistons (14), each piston having a first end pivotally connected to a first pivot point (15) of a base bracket (17) of said boom (12) and a second end pivotally connected to a second pivot point (19) on an extension bracket (23) of said boom (12), for raising and lowering said boom (12);
first and second sensors (21) each mounted at different locations on said extension bracket (23), both sensors monitoring deformations of said extension bracket (23), an average of measurements of the first and second sensors providing a first load value representative of an axial deflection of the boom (12), a difference between the measurements of the first and second sensors providing a second load value representative of a lateral deflection of the boom (12); and
a control system (58) for receiving signals from said first and second sensors (21) and controlling power delivered to said one or more pistons (14) based on said received signals.

2. The utility truck of claim 1, wherein the control system (58) is configured to convert the signals received from the sensors (21) into force values exerted on said boom and to compare said force values to a force threshold.

3. The utility truck of claim 2, wherein control system (58) is configured to shut down the power delivered to the pistons (14) when said force threshold reaches a predetermined threshold.

4. The utility truck of claim 2, wherein control system (58) is configured to reduce the power delivered to the pistons (14) when said force threshold reaches a predetermined threshold so as to slow down a speed of operation of the pistons (14).

5. The utility truck of claim 2, wherein control system (58) is configured to emit an alarm when said force threshold reaches a predetermined threshold.

6. The utility truck of claim 1, wherein the first and second sensors (21) are respectively mounted at symmetrical locations with respect to the boom (12).

7. The utility truck of claim 1, wherein the telescoping segments slide by means of hydraulic power.
